(19) United States
(12) Patent Application Publication
(10) Pub. No.: US 2020/0068192 A1
(43) Pub. Date: Feb. 27, 2020

(54) VIDEO MANAGEMENT SYSTEM FOR VIDEO DEVICES IN A BUILDING SYSTEM

(71) Applicant: Johnson Controls Technology Company, Auburn Hills, MI (US)

(72) Inventor: Jason Pelski, Boca Raton, FL (US)

(73) Assignee: Johnson Controls Technology Company, Auburn Hills, MI (US)

(21) Appl. No.: 16/547,022

(22) Filed: Aug. 21, 2019

Related U.S. Application Data
(60) Provisional application No. 62/721,526, filed on Aug. 22, 2018.

(51) Int. Cl. H04N 17/00; H04N 5/247; H04N 7/18; G08B 21/18

(52) U.S. Cl. CPC H04N 17/002; G08B 21/18; H04N 7/181; H04N 5/247

(57) ABSTRACT

The present disclosure is a method for monitoring video devices of a plurality of buildings. The method comprises receiving video device data of a plurality of video devices of the plurality of buildings. The method further comprises determining a health state of each of the plurality of video devices based on video device data. The health state is a current state of the video device and includes an healthy state or an unhealthy state. The method also includes generating an alert in response to a determination that the health of one of the plurality of video devices is the unhealthy state and sending the alert to an external device. In response to the determination that the health of one of the plurality of video devices is the unhealthy state, the method includes automatically resolving the unhealthy state.

### CROSS-REFERENCE TO RELATED PATENT APPLICATION

This application claims the benefit of and priority to U.S. Provisional Application No. 62/721,526 filed Aug. 22, 2018, the entire disclosure of which is incorporated herein by reference.

### BACKGROUND

The present disclosure relates generally to building surveillance systems. The present disclosure relates more particularly to video devices for monitoring a building system.

A building can include surveillance or security equipment such as one or more video devices configured to record video inside and outside of the building. Such video devices can deter criminal activities to prevent dangers to employee health, reduce safety risks, prevent asset theft, prevent product contamination, and protect company stock value. However, there are instances in which the video devices may be inoperable, and the inoperability is not communicated to an entity that can quickly implement a repair. In such instances, the benefits of having video devices are defeated, and significant losses may occur as a result.

### SUMMARY

One embodiment of the present disclosure is a method for monitoring video devices of a plurality of buildings. The method comprises receiving video device data of a plurality of video devices of the plurality of buildings. The method further comprises determining a health state of each of the plurality of video devices based on video device data. The health state is a current state of the video device and includes a healthy state or an unhealthy state. The method also includes generating an alert in response to a determination that the health of one of the plurality of video devices is the unhealthy state and sending the alert to an external device. In response to the determination that the health of one of the plurality of video devices is the unhealthy state, the method includes automatically implementing an action to resolve the unhealthy state.

Another embodiment of the present disclosure is a system for monitoring video devices of a plurality of buildings. The system includes one or more memory devices configured to store instructions. When executed on one or more processors, the instructions cause the one or more processors to receive video device data of a plurality of video devices of the plurality of buildings. A health state of each of the plurality of video devices is determined based on the video device data of each of the plurality of video devices. The health state is a current state of the video device and is an healthy state or an unhealthy state. Determining the health state comprises comparing the video device data to a set of rules, the set of rules including a license warning rule associated with a software, a license length, and a warning length, where the health state of each of the plurality of video devices is based on the comparison. An alert is generated in response to a determination that the health of one of the plurality of video devices is the unhealthy state, and the alert is sent to an external device.

Another embodiment of the present disclosure is a building system comprising building equipment configured to operate to control one or more security conditions of the building, the building equipment comprising one or more video devices configured to collect video data. The building system further comprises a processing circuit configured to receive video device data of a plurality of video devices of the plurality of buildings. The processing circuit is also configured to determine a health state of each of the plurality of video devices based on the video device data of each of the plurality of video devices. The health state is a current state of the video device and is an healthy state or an unhealthy state. Determining the health state comprises comparing the video device data to a set of rules, the set of rules including a license warning rule associated with a software, a license length, and a warning length, where the health state of each of the plurality of video devices is based on the comparison. The comparison includes determining that a health state of the video device is the unhealthy state in response to a determination that the difference between a license start date of the software and the license length is the same or less than the warning length. An alert is generated in response to a determination that the health of one of the plurality of video devices is the unhealthy state, and the alert is sent to an external device. In response to determining the health state of one of the plurality of video devices is the unhealthy state, an action is implemented to automatically resolve the unhealthy state, and a graphical representation of the health state of each of the plurality of video devices is provided on a user display.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic drawing of a building with a security camera system and a parking lot, according to an exemplary embodiment.

FIG. 2A is a block diagram of multiple buildings including the building of FIG. 1 communicating to a connected video server via data collectors, according to an exemplary embodiment.

FIG. 2B is a block diagram of a system and a process for resolving video device conflicts that can be performed by the connected video server of FIG. 2A, according to an exemplary embodiment.

FIG. 2C is a flow diagram of another process for resolving video device conflicts that can be performed by the connected video server of FIG. 2A, according to an exemplary embodiment.

FIG. 3 is a block diagram of the connected video server of FIG. 1 for monitoring video devices in a building system, according to an exemplary embodiment.

FIG. 4 is a flow diagram of a process for monitoring video devices in a building system that can be performed by the connected video server of FIG. 1, according to an exemplary embodiment.

FIG. 5 is a schematic drawing of a user interface for reporting video device information that the connected video server of FIG. 2A can generate, according to an exemplary embodiment.

FIG. 6 is a bar graph that can be displayed in a user interface illustrating system down time, according to an exemplary embodiment.

FIG. 7 is a pie chart that can be displayed in a user interface illustrating customer requirements for a video management system, according to an exemplary embodiment.

FIG. 8 is a trend chart that can be displayed in a user interface illustrating a relationship between on-site video device conflict fixes and usage of a monitoring platform, according to an exemplary embodiment.

FIG. 9 is a line graph that can be displayed in a user interface illustrating reductions in truck dispatches and customer maintenance, according to an exemplary embodiment.

FIG. 10 is a bar graph that can be displayed in a user interface illustrating revenue generated by a video management system, according to an exemplary embodiment.

### DETAILED DESCRIPTION

### Overview

Referring generally to the FIGURES, systems and methods for monitoring video devices in a building system are shown, according to various exemplary embodiments. In some cases, there are a large number of video devices (e.g., security cameras, analysis systems, video storage systems, etc.) within a single building system. Oftentimes, a video management system (VMS) monitors one or more building systems. The VMS can include a monitoring platform configured to determine the health of a video device. In the case that a video device is unstable, the monitoring platform may generate and send an alert prompting for the resolution of a video device conflict. The conflict may be resolved remotely by a remote service resolution (RSR) team or on-site (e.g., dispatch service truck). In some embodiments, the monitoring platform may store video footage and/or video device statistics and other data.

Customers in the video security market may install video surveillance systems to deter criminal activities to prevent dangers to employee health, safety risks, asset theft, product contamination, and protect company stock value. Video clips may be used as evidence for prosecution and insurance claims making video surveillance systems a critical security tool for protecting business operations. In some embodiments, cloud based video analytics can be integrated into existing video systems to extend value by improving store operations such as conversion sale rates and cash register controls. A majority of cameras installed in a video surveillance system may be “networked cameras,” meaning they connect directly into some form of video management system (VMS) through internet protocol (IP). VMS primary function is to give the security management team tools to setup and configure cameras, view video, record, search, and integrate adjacent edge devices (intrusion, access control, triggers, and light strobes). Video power over Ethernet (POE) systems are gaining rapid adoption because of the ease of install and compatibility into building management systems (BMS). Most commercial VMS systems allow for integration of intrusion and access control systems so events can trigger video. VMS are either boxed systems, server based, or hybrid using the Information Technology (IT) network for connectivity, but this is where IT's responsibility stops as the installation of devices, configuration, software licenses, maintenance, and service is typically the responsibility of security management team, which do not traditionally come from an IT background.

Video systems are increasingly complex and costly to manage. Security teams do not know when video cameras have malfunctioned potentially missing a nefarious incident and risking life safety and asset loss. Unlike an existing break/fix model of resolving equipment failures, after the critical need of recording, the event has passed. The critical event itself is usually the trigger to retrieve video; however customers quickly realize that if the video system or camera was non-functional, no evidence was preserved making threat avoidance, criminal conviction, and/or insurance claims much more difficult or impossible to prove. Additionally, VMS setup and configuration is difficult across a fragmented component market where compatibility testing isn't comprehensive and interoperability is trial and error. Security teams are responsible for managing interoperability across cameras, servers, SW licenses, storage, clients, accounts, configurations, and analytics.

A health monitoring platform for managing video services may help reduce overall cost to serve customers. The health monitoring platform may provide customers with increased system uptime and reduced year over year (YOY) maintenance costs. The key performance indicators (KPIs) of the platform may include first time fix and serviceability metrics, trackable service level agreements (SLAs), and overall peace of mind. The platform may allow for more remote fixes and reduce on-site fixes furthering the cost reduction. Equipment replace sales may increase because the monitoring platform can provide data that identifies failures and therefore provides sales leads.

The health monitoring platform and its company may encounter a few challenges. Security monitoring companies may have to implement measures to avoid cybersecurity attacks that damage the reputation of the company and exposes sensitive customer information. In addition, cloud data privacy policy is continually being reviewed and many European Union (EU) countries have implemented safe guards to keep certain data from leaving the country. These safe guards may make architecting the health monitoring platform more difficult and more expensive, particularly for EU customers.

### Connected Video Management

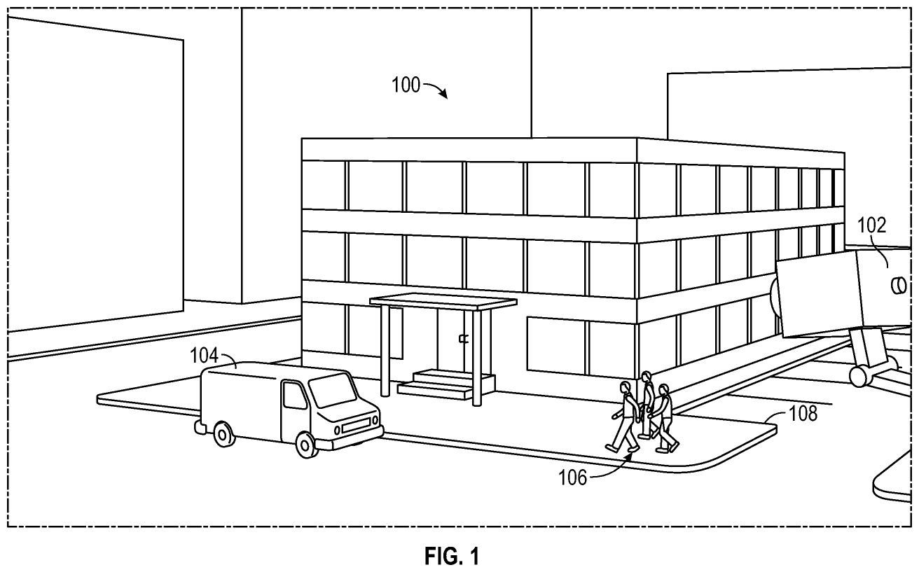

Referring now to FIG. 1, a building 100 with a security camera 102 and a parking lot 110 is shown, according to an exemplary embodiment. The building 100 is a multi-story commercial building surrounded by a parking lot, but can be any type of building in various implementations. The building 100 may be a school, a hospital, a place of business, a residence, an apartment complex, etc. The building 100 may be associated with the parking lot 106.

Both the building 100 and the parking lot 110 are at least partially in the field of view of the security camera 102, in some implementations. In some embodiments, multiple security cameras 102 may be used to capture the entire building 100 and parking lot 110 not in (or in to create multiple angles of overlapping or the same field of view) the field of view of a single security camera 102. The parking lot 110 may be used by one or more vehicles 104 where the vehicles 104 may be either stationary or moving (e.g. delivery vehicles). The building 100 and parking lot 110 may be further used by one or more pedestrians 106 who can traverse the parking lot 110 and/or enter and/or exit the building 100. The building 100 may be further surrounded by a sidewalk 108 to facilitate the foot traffic of one or more pedestrians 106, facilitate deliveries, etc. In other embodiments, the building 100 may be one of many buildings belonging to a single industrial park or commercial park having a common parking lot and security camera 102. In another embodiment, the building 100 may be a residential building or plurality of residential buildings that share a common roadway or parking lot.

In some embodiments, a security system may reside in building 100. The security system may be comprised of, but is not limited to, one or more security cameras 102, a monitoring system, and/or an access control system. The security cameras 102 may be used to capture rooms, passageways, lobbies, offices, and/or stairwells. The footage captured on the security cameras 102 may be viewable via the monitoring system. Security guards of building 100 may use the monitoring system to review recent activity in building 100.

Building 100 may have an access control system to monitor access to various entryways, rooms, floors, and restricted areas in general. In certain embodiments, the security system of building 100 may utilize biometrics and/or physical access cards. In some embodiments, biometrics (e.g., facial recognition) may be used to identify a user requesting access in building 100 and verify their identity. The biometrics access control system may scan a user's face, finger, and/or other body part to verify their identity. The scanned portion can be compared to existing data in the system for verification. Physical access cards may also be used to monitor access inside building 100. A user may obtain a physical identification (ID) card that provides them access to various entities of building 100. With the discussed methods of access control, a user may be given access to the entire building 100, a particular room, floor, or entryway, or a plurality of rooms, floors, and/or entryways. User access rights may be determined by the management of building 100.

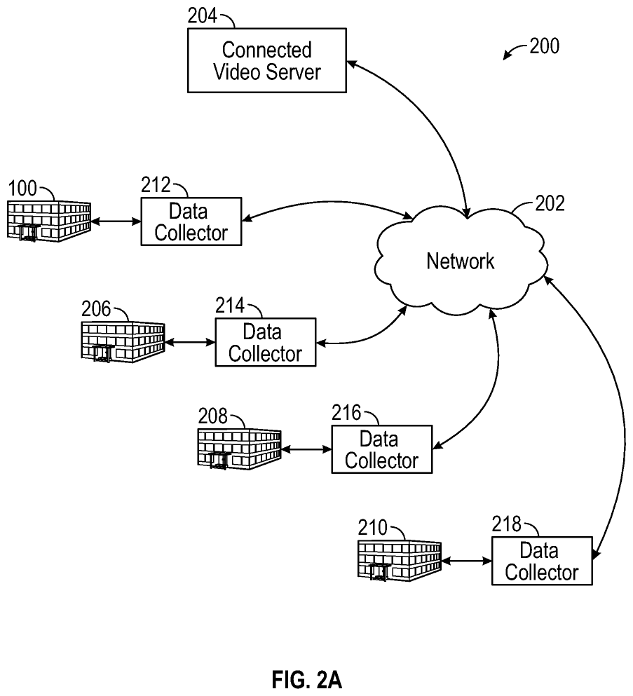

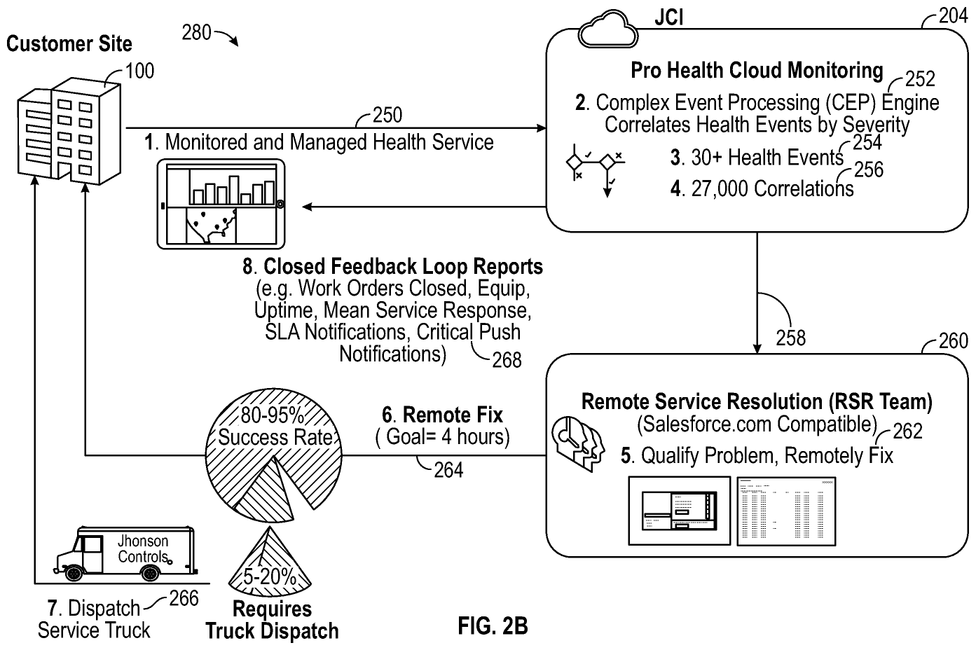

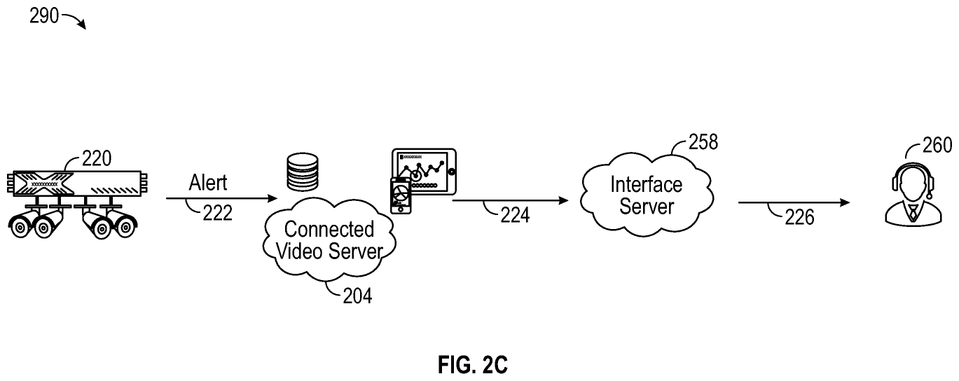

Referring now to FIG. 2A, a system 200 including multiple pieces of building equipment (e.g., one or more video devices in each building) connected to a connected video server 204 via data collectors is shown, according to an exemplary embodiment. System 200 is shown to include multiple buildings, building 100 as described with reference to FIG. 1, building 206, building 208, and building 210. Buildings 206-210 may be the same and/or similar to building 100 or may be different. In some embodiments, the buildings are all owned by a single company and/or may be located on a single campus, on multiple campuses, in multiple states, and/or in multiple countries. Each building 100 and 206-210 is shown to have a data collector, data collectors 212-218. Data collectors 212-218 may be controllers, gateways, computer systems, and/or any other device that can collect data for a building and push the data to a server. In some embodiments, buildings 100 and 206-210 may have one or more data collectors 212-218. Local regulations of data security and/or encryption can be met by each building 100 and 206-210 and/or data collector 212-218 based on the location (e.g., country, state, district) that each building 100 and 206-210 and/or data collector 212-218 are located. A customer associated with one or more of buildings 100 and 206-210 should have a provision to decide that their data when stored in cloud, the data center should be in their respective country. For example, a particular country, e.g., Spain, only wants data to be stored in Spain data centers. This should be a provision while doing application configuration.

Connected video server 204 may store data collected from buildings 100 and 206-210 via data collectors 212-218. As shown in FIG. 2A, the data collectors 212-218 send data to the connected video server 204 via the network 202. Further, connected video server 204 is shown to receive data from the data collectors 212-218 of the buildings 100 and 206-210. Data sent and received may include captured video, building settings, video settings, and alerts.

In some embodiments, one or more of data collectors 212-218 are “on-premises” collectors. These collectors may run building software (e.g., METASYS®) and may run “data collector” software. In some embodiments, one or more of data collectors 212-218 may be “hosted.” In this regard, the data collectors 212-218 may only run the data collector software while connected video software server 204 may run video device monitoring software. For this reason, connected video server 204 can be configured to perform the control functions of “on-premises” collectors.

When the data collectors 212-218 are hosted, data collectors 212-218 may be “lightweight” data collectors. These data collectors may have low processing power, low memory, and/or low data storage. In some embodiments, hosted data collectors may have a higher maximum point list than the on-premises collectors. The data collectors 212-218 may push collected data to the cloud (e.g., to a cloud server). In various embodiments, one of data collectors 212-218 may store collected data locally in a building server and/or use a local building server as a cloud server. This may accommodate multiple buildings at a particular site (e.g., a university campus). In some embodiments, instead of storing data in cloud storage (e.g., MICROSOFT AZURE®) the collected data may be stored in a local building server. In some embodiments, a particular data collector of the building may act as the local building server. However, a user may be able to access the locally stored data via the cloud even though the data is not automatically pushed to a cloud server.

In some instances, when Internet connection for one of buildings 100 and 206-210 is interrupted, the data collectors 212-218 for the building with an Internet outage may buffer data until Internet connection is reestablished. Then, after the Internet connect is reestablished, data collectors 212-218 may push the data to a cloud server and/or reconcile collected data. In some embodiments, communication between data collectors 212-218 and the cloud application is performed via a secure channel. In case of any connection issues between one of data collectors 212-218 and connected video server 204, connection information can be logged by both the collectors 212-218 as well on connected video server 204.

Still referring to FIG. 2A, network 202 may include the Internet and/or other types of data networks, such as a local area network (LAN), a wide area network (WAN), a cellular network, a satellite network, or any other type of data network or combination thereof. Network 202 may include any number of computing devices (e.g., computers, servers, routers, network switches, etc.) configured to transmit, receive, or relay data. Network 202 may further include any number of hardwired and/or wireless connections. For example, data collectors 212-218 may communicate wirelessly (e.g., using a WiFi or cellular radio, etc.) with a transceiver that is hardwired (e.g., via a fiber optic cable, Ethernet, a CAT5 cable, etc.) to a computing device of network 202.

Network 202 may include services that facilitate managing the wireless and/or wired communication with data collectors 212-218. Network vendors may include, for example, cellular telecommunications providers as well as internet service providers. Communications via network 202 may leverage enterprise contracts and partnerships to optimize the cost of data transmission. Many network carriers provide a secure connection option as a part of premium services. However, a similar degree of network security can be achieved via employing trusted platform modules in data collectors 212-218 and using encrypted messaging. Data collectors 212-218 may use advanced message queuing protocol (AMQP) via an Internet-based secure transport. In various embodiments, each device and/or a portion of the devices communicating over network 202 use transport layer security (TLS), secure sockets layer (SSL), and/or any other cryptographic protocol to ensure integrity and/or security of the messages sent over network 202.

Still referring to FIG. 2A, connected video server 204 can maintain transmission health information for each of data collectors 212-218 and update the information periodically. In some embodiments, to optimize Internet data usage, data collectors 212-218 may collect data for buildings 100 and 206-210 and transmit the data to connected video server 204 in batches. A user may modify the size and interval of the batches of data via data collectors 212-218 and/or connected video server 204.

Connected video server 204 may partition data received from data collectors 212-218 based on customer. For example, building 100 and data collector 212 may be owned by customer A while buildings 206-208 and data collectors 212-218 may be owned by customer B. Both customer A and B can log into cloud server 432 via a URL and/or portal and see data relating to their respective equipment. The information may include customer name, serial numbers for data collectors 212-218, software versions for data collectors 212-218, video device settings, captured video, and status of a video device. In various embodiments, connected video server 204 may generate reports based on the information. Connected video server 204 may use the reports to generate a user interface to be displayed on an external user device.

Referring now to FIG. 2B, a diagram of a process 280 for resolving video device conflicts is shown, according to an exemplary embodiment. The process 280 can resolve video device conflicts, for example, device faults, via the connected computing architecture as described herein. Connected video server 204, data collectors 212-218, and/or any other computing device as described herein, either on-premises or cloud based, can be configured to perform the process 280.

The process 280 may begin at a customer site, specifically building 100. Building 100 may have one or more of the characteristics described with reference to FIG. 1. Customer site 100 may contain one or more video devices (e.g., security camera 102). Monitoring platform connected video server 204 may receive video device data (250), for example via data collectors 212-218. Within connected video server 204, a complex event processing engine 252 may process the video device data (250) and determine the health of the video device. Connected video server 204 may use stored health events (254) and other video device correlations (256) to make its determinations. In some embodiments, connected video server 204 may generate and display feedback loop reports 268 via a user device.

Feedback loop reports may include closed work orders, equipment uptime, mean service response, and/or critical push notifications. Connected video server 204 may send an alert requesting a video device conflict to be resolved (258). Upon receiving an alert, a remote service resolution (RSR) team 262 may attempt to identify and categorize the problem and fix it remotely. In the case that the problem cannot be fixed remotely, an on-site fix (e.g., dispatch service truck 266) may be required. Conflict resolution reports may be displayed via a user device (264). For example, these conflict resolution reports may demonstrate the success rate of the fix and/or the amount of time the fix took.

Referring now to FIG. 2C, another process 290 of resolving video device conflicts is shown, according to an exemplary embodiment. The process 290 can identify and resolve video device conflicts, for example, device faults, via the connected computing architecture as described herein. Camera system 220, connected video server 204, data collectors 212-218, and/or any other computing device as described herein, either on-premises or cloud based, can be configured to perform the process 290.

Camera system 220 may send an alert to the connected video server 204 notifying it of some event (222). The alert may be an alarm such as a storage alarm, voltage sensor alarm, or a content age alarm. The alert may also indicate a failure (e.g. DVR board failure), a warning (e.g. license warning), or video disruption (e.g. video loss and camera disconnected). The connected video server 204 receives the alert and determines how to proceed. The connected video server 204 will log the alert and any relevant event data. For example, the connected video server 204 may receive a server “server offline” alert. This may not be a crucial event so the connected video server 204 may log the event and wait 15 minutes before acting upon it. Upon determining that an event requires a solution, the connected video server 204 may send data to an interface server 258 to display a user interface and start a case with the resolution team 260 (224). The interface server 258 will generate the necessary report to alert a member of the resolution team 260. A member of the resolution team 260 may view the case may be created within 2 hours of receiving information from the connected video server 204 and the resolution team 260 may monitor the case queue. A member of the resolution team 260 may first attempt to resolve the issue remotely. If unable to resolve remotely, a field service technician may be dispatched for an on-site solution. The case may then be closed with appropriate disposition.

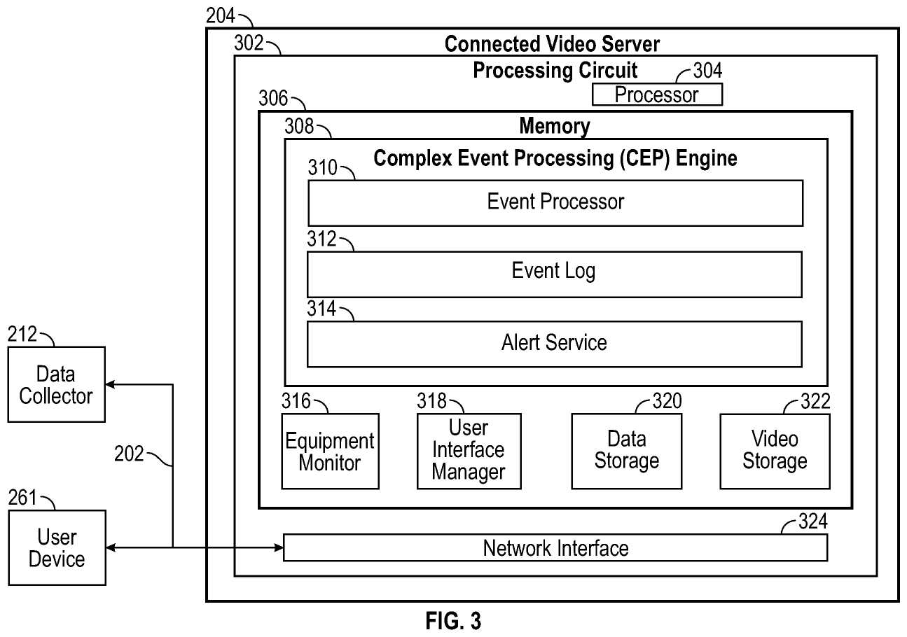

Referring now to FIG. 3, a block diagram illustrating connected video server 204 as described with reference to FIG. 2 in greater detail, according to an exemplary embodiment. Connected video server 204 is configured to monitor video devices in a building system. Connected video server 204 is shown to include a processing circuit 302 and a network interface 324. Network interface 324 may be used to facilitate communication between connected video server 204 and a data collector 212 and/or user device 261.

Network interface 324 can include wired or wireless communications interfaces (e.g., jacks, antennas, transmitters, receivers, transceivers, wire terminals, etc.) for conducting data communications with client device, server 204 or other external systems or devices. In various embodiments, communications conducted via interface 324 can be direct (e.g., local wired or wireless communications) or via a communications network (e.g., a WAN, the Internet, a cellular network, etc.). For example, network interface 324 can include an Ethernet card and port for sending and receiving data via an Ethernet-based communications link or network. In another example, network interface 324 can include a WiFi transceiver for communicating via a wireless network. In another example, network interface 324 can include cellular or mobile phone communications transceivers. In one embodiment, network interface 324 is a power line communications interface and/or an Ethernet interface.

Processing circuit 302 is shown to include a processor 304 and memory 306. Processor 304 can be a general purpose or specific purpose processor, an application specific integrated circuit (ASIC), one or more field programmable gate arrays (FPGAs), a group of processing components, or other suitable processing components. Processor 304 is configured to execute computer code or instructions stored in memory 306 or received from other computer readable media (e.g., CDROM, network storage, a remote server, etc.).

Memory 306 can include one or more devices (e.g., memory units, memory devices, storage devices, etc.) for storing data and/or computer code for completing and/or facilitating the various processes described in the present disclosure. Memory 306 can include random access memory (RAM), read-only memory (ROM), hard drive storage, temporary storage, non-volatile memory, flash memory, optical memory, or any other suitable memory for storing software objects and/or computer instructions. Memory 306 can include database components, object code components, script components, or any other type of information structure for supporting the various activities and information structures described in the present disclosure. Memory 306 can be communicably connected to processor 304 via processing circuit 302 and can include computer code for executing (e.g., by processor 304) one or more processes described herein. When processor 304 executes instructions stored in memory 306, processor 304 generally configures connected video server 204 (and more particularly processing circuit 302) to complete such activities.

Still referring to FIG. 3, memory 306 includes an equipment monitor 316. Equipment monitor 316 can monitor the status of any video devices at a customer site. Equipment monitor 316 may ping all video devices at a customer site via network interface 324. If equipment monitor 316 receives a response from a video device, for example via data collector 212 and network interface 324, equipment monitor 316 may determine the video device is stable. If equipment monitor 316 does not receive a response from a video device, for example via data collector 212 and network interface 324, equipment monitor 316 may determine the video device is unstable. In the case of an unstable video device, the equipment monitor 316 may send a message to the complex event processing engine 308 for further handling. In some embodiments, the equipment monitor 316 may wait a predetermined amount of time before acting upon the absence of a message. In certain embodiments, the equipment monitor 316 may not ping the video devices, but may wait until it receives a message from a video device, for example via a data collector 212.

Memory 306 includes complex event processing (CEP) engine 308 configured to handle all video device events in some embodiments. Complex event processing engine 308 is shown to include an event processor 310, an event log 312, and an alert service 314. Event processor 310 may be configured to process all of the incoming events. Event processor 310 may determine how severe the event is and may determine if a solution is necessary. Event processor 310 may determine that the event needs to be logged, for example in an event log 312. Event log 312 stores video device events with any relevant information (e.g., time, severity, etc.). For instance, if a particular video camera is down for 30 minutes, the event may be categorized as “high” severity and may be logged in the event log 312. Upon logging video device events, alert service 314 may generate alerts regarding the status of a video device. For example, in the case that a video device is down, an alert may be generated to alert the appropriate party (e.g., resolution team) that a solution is needed to bring the video device back up. Alert service 314 may receive the necessary data from event log 312, data storage 320, and/or video storage 322.

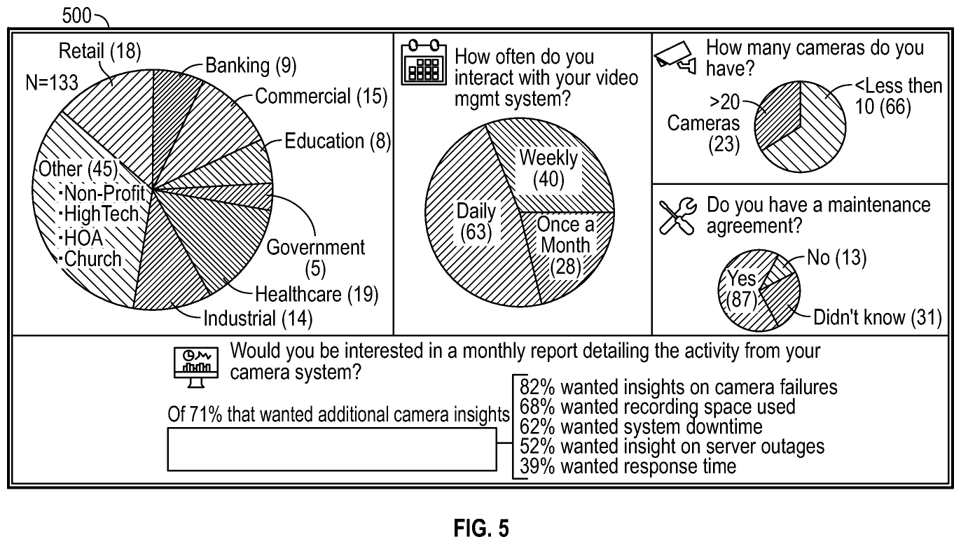

Connected video server 204 is shown to include a user interface manager 318. User interface manager 318 may generate user interfaces regarding video device information. Generated user interfaces may include reports for a resolution team and/or building management. In some embodiments, user interface manager 318 may generate user interfaces to display video footage from a video device. Examples of user interfaces generated by user interface manager 318 are explained in greater detail with connection to FIGS. 5-10. User interface manager 318 may receive its data to generate user interfaces from event log 312, alert service 314, data storage 320, and/or video storage 322. User interface manager 318 may send a user interface to be displayed on a user device 261 via the network interface 324.

Still referring to FIG. 3, connected video server 204 is shown to include a data storage 320. Data storage 320 can store various data regarding video management systems of a BMS. Data stored may include video device statistics (e.g., number of video cameras at each customer site), video device specifications (e.g., video camera model), and/or history of video device conflicts/resolutions. The complex event processing engine 308 and/or equipment monitor 316 may choose to store data in the data storage 320. In some embodiments, data storage 320 may be a database and/or data structure. Data may be retrieved from the data storage 320, for example, by the user interface manager 318.

Connected video server 204 is shown to include a video storage 322. Video storage 322 may store video footage received from data collector 212 via network interface 324. Video footage may originate from any of the video devices (e.g., security camera) at a customer site. Data collector 212 may send all video footage or a limited quantity of video footage (e.g., pending storage limits and thresholds of data sending) from a video device to be stored in video storage 322. In some embodiments, video storage 322 may be a database. For example, video storage 322 may be a relational database, object-oriented database, network database and/or hierarchical database. In certain embodiments, video storage 322 may be a data structure. For example, video storage may be stored in an array or list in video storage 322. Video data may be retrieved from the video storage 322, for example by the equipment monitor 316 and/or user interface manager 318.

Still referring to FIG. 3, network interface 324 can facilitate communications between connected video server 204 and external systems, devices, or applications. For example, network interface 324 can be used by connected video server 204 to communicate with user device 261 (e.g., a tablet, a laptop computer, a smartphone, a desktop computer, a computer workstation, etc.). Network interface 324 may send user interfaces to be displayed on user device 261. In some embodiments, network interface 324 may receive messages from user device 261 upon displaying user interfaces. Network interface 324 may be used by connected video server 204 to send and receive data relating to video cameras to and from data collector 212.

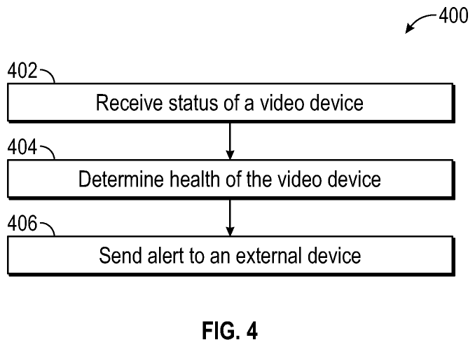

Referring now to FIG. 4, a process 400 is shown of monitoring a video device in a building system, according to an exemplary embodiment. In step 402, the monitoring platform can receive a status of a video device. Connected video server 204, specifically the complex event processing engine 308, may receive video device data, for example from a data collector 212 via network interface 324. The complex event processing engine 308 may store the video device data in the data storage 320 and/or video storage 322. In step 404, the monitoring platform can determine the health of the video device. Event processor 310 may process the video device data to determine if the video device has a conflict and needs a resolution. Pending the conclusion of the event processor 310, the determined result may be logged in event log 312. In step 406, responsive to the determination of the video device's health, the monitoring platform can send an alert to an external device. The alert service 314 of connected video server 204 may generate an alert. In some embodiments, the alert may prompt a video device conflict to be resolved. The alert may be sent to an external device, for example a user device 261, via network interface 324.

Referring now to FIGS. 5-10, examples of a user interface and graphs that can be displayed in a user interface are shown, according to an exemplary embodiment. The user interface may be generated by user interface manager 318 of connected video server 204. The user interface may be a web service or an application. The user interface could be displayed on an external user device (e.g., iPad, computer, mobile device etc.). The external user device may be operated by management of a building, a member of a resolution team, or by the company who owns the video management system. The user interface may report a video device conflict, may indicate that a video device conflict has been resolved, or may demonstrate the value of the video management system.

Referring now to FIG. 5, a schematic drawing of a user interface 500 for reporting video device information that the connected video server 204 of FIG. 2A can generate is shown, according to an exemplary embodiment. In user interface 500, many charts are shown indicating the usage of a building's video management system and its users' habits. A pie chart in the user interface displays the industry usage of the VMS. For example, 18 users use their VMS in a retail industry, 19 users use their VMS in a healthcare industry, and 15 users use their VMS commercially. Another pie chart in the user interface 500 displays the frequency of user interaction with the VMS. For instance, 63 users use their VMS daily, 40 users use their VMS weekly, and 28 users use their VMS once a month. In another pie chart, the number of cameras a VMS manages is displayed. In this case, 23 video management systems have greater than 20 video cameras while 66 video management systems have less than 10 video cameras. Another pie chart in the user interface displays the number of users that have and don't have a maintenance agreement. For instance, 87 users have a maintenance agreement, 13 users don't have a maintenance agreement, and 31 users don't know if they have a maintenance agreement. This user interface 500 could be displayed on a user device operated by a manager of the building or by a member of the sales team of the building. The user interface 500 may provide insight to the building's video management system and how it is being used.

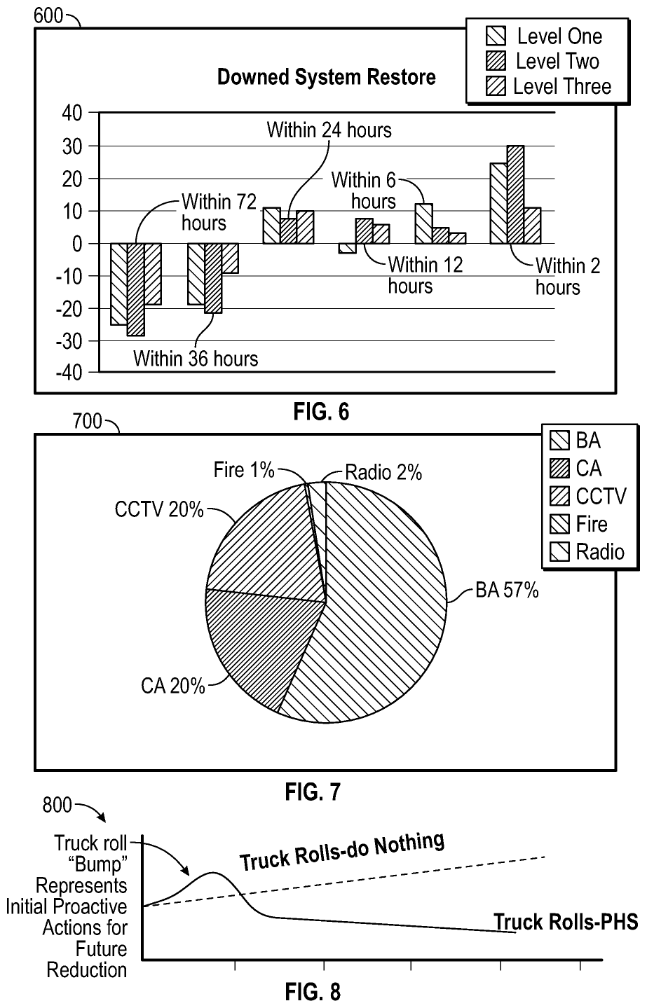

Referring now to FIG. 6, a bar graph 600 that can be displayed in a user interface illustrating down time is shown, according to an exemplary embodiment. Bar graph 600 displays the amount of time systems were down before being restored. Three levels are displayed, indicating the severity of the conflict. This user interface could be displayed on a user device operated by a member of a resolution team. The resolution team could use the statistics displayed to modify their conflict resolution plans in order to decrease the amount of down time in systems that they are responsible for. For example, bar graph 600 shows that numerous systems were down for 36-72 hours before being restored. In some embodiments, customers may expect their downed system be fully restored within 24 hours. Members of the resolution team could use the data shown in bar graph 600 to better serve their customers.

Referring now to FIG. 7, a pie chart 700 that can be displayed in a user interface illustrating customer requirements for a video management system is shown, according to an exemplary embodiment. Pie chart 700 indicates customer requirements, such as Access, Video, and Radio, for a VMS. In this example, Access and Video account for 97% of the customer requirement. Moreover, 95% of Access and Video issue resolution involves some type of customer training. Pie chart 700 may be displayed in a user interface and the user interface may be displayed on a device operated by a member of a resolution team in order for them to better determine how to help their customers.

Referring now to FIG. 8, a trend chart 800 that can be displayed in a user interface illustrating a relationship between on-site video device conflict fixes and usage of a monitoring platform is shown, according to an exemplary embodiment. Trend chart 800 demonstrates the trend in ‘truck rolls’ for using a monitoring platform with a video management system versus for not using a monitoring platform with a video management system. A ‘truck roll’ trend line indicates when a member of a resolution team has to physically drive out to a customer site in order to resolve a video device conflict. Trend chart 800 exhibits that overall there are less on-site visits when a monitoring platform is implemented. Trend chart 800 may be displayed in a user interface and the use interface may be displayed on a user device operated by a member of resolution team or on a user device operated by a member of management for a customer site.

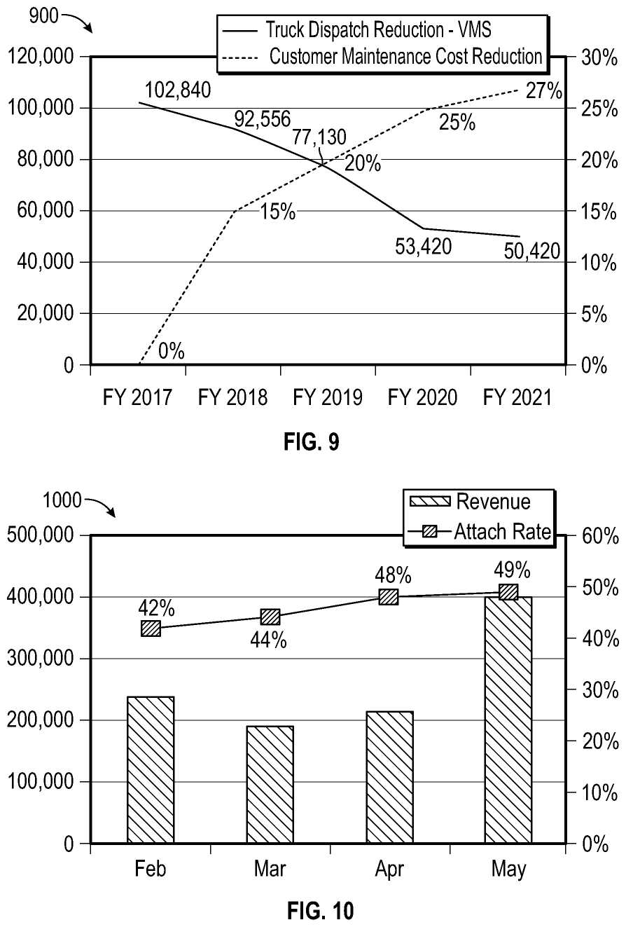

Referring now to FIG. 9, a line graph 900 that can be displayed in a user interface illustrating reductions in truck dispatches and customer maintenance is shown, according to an exemplary embodiment. Line graph 900 displays the forecasted reduction in truck dispatch and customer maintenance costs. This particular graph indicates that customer service and maintenance costs are expected to drop between 15% and 30% over the life of the video management system. Existing data from the monitoring platform may be extrapolated in order to create the data and trend lines displayed in bar graph 900. Line graph 900 may be displayed in a user interface and the user interface may be displayed for future customers interested in the installation of the video management system to indicate how successful it has been. The user interface may also be shown to resolution teams to show their progress.

Referring now to FIG. 10, a bar graph 1000 that can be displayed in a user interface illustrating revenue generated by a video management system is shown, according to an exemplary embodiment. Bar graph 1000 displays the revenue the video management system has generated over a period of time, specifically months February to May. The video management system company may view this user interface in order to forecast sales in the upcoming months or years or they may utilize this graph to adjust marketing plans. For example, if the company notices that their generated revenue is not hitting their revenue goal, they may make more of an effort to advertise or sell the video management system. The company may also be able to determine a trend in their revenue. For example, in bar graph 1000, months February through April are fairly consistent, but May had a big spike in revenue indicating that may be months closer to summer generate more revenue. The company may use this data in planning and budgeting throughout the year. Bar graph 1000 may be displayed in a user interface and the user interface may be displayed on a user device.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for monitoring video devices of a plurality of buildings, the method comprising:
receiving, by a monitoring platform, video device data of a plurality of video devices of the plurality of buildings;
determining, by the monitoring platform, a health state of each of the plurality of video devices based on the video device data, wherein the health state is a current state of the video device and is an healthy state or an unhealthy state;
generating, by the monitoring platform, an alert in response to a determination that the health of one of the plurality of video devices is the unhealthy state;
sending, by the monitoring platform, the alert to an external device; and
in response to the determination that the health of one of the plurality of video devices is the unhealthy state, automatically implementing an action to resolve the unhealthy state.

2. The method of claim 1, wherein determining, by the monitoring platform, the health state of each of the plurality of video devices based on the video device data comprises performing a complex event processing (CEP) analysis on the video device data, wherein the video device data comprises a plurality of video device events.

3. The method of claim 1, wherein the monitoring platform comprises:
a complex event processing (CEP) engine configured to process and log video device events and generate alerts corresponding to the events;
an equipment monitor configured to monitor all devices relating to the plurality of buildings; and
a user interface manager configured to generate user interfaces to be displayed on an external device.

4. The method of claim 1, wherein automatically implementing the action to resolve the unhealthy state comprises causing, by the monitoring platform, a maintenance platform to:
generate a new response case data structure, the response case data structure indicating that the video system device is experiencing a fault; and
add the new response case data structure to a queue list of a plurality of other response case data structures.

5. The method of claim 1, wherein determining, by the monitoring platform, the health state of each of the plurality of video devices comprises:
comparing the video device data to a set of rules; and
determining the health state of each of the plurality of video devices based on the comparison.

6. The method of claim 5, wherein the set of rules comprises a video server offline rule associated with a predefined offline time;
wherein comparing the video device data to the video server offline rule comprises:
determining a length of time that a video server the plurality of video devices has been offline based on the video device data;
determining whether the length of time that the video server has been offline is the same as or greater than the predefined offline time of the video server offline rule;
wherein determining the health state of each of the plurality of video devices based on the comparison comprises determining that a health state of the video server is the unhealthy state in response to a determination that the length of time that the video server has been offline is the same as or greater than the predefined offline time of the video server offline rule.

7. The method of claim 5, wherein the set of rules comprises a video device disconnected rule;
wherein comparing the video device data to the video device disconnected rule comprises determining whether a video device has been disconnected based on the video device data;
wherein determining the health state of each of the plurality of video devices based on the comparison comprises determining that a health state of the video device is the unhealthy state in response to a determination that the video device has been disconnected.

8. The method of claim 5, wherein the set of rules comprises a license warning rule associated with a software, a license length, and a warning length;
wherein comparing the video device data to the license warning rule comprises:
determining whether the video device uses the software;
determining whether a difference between a license start date of the software and the license length is the same or less than the warning length;
wherein determining the health state of each of the plurality of video devices based on the comparison comprises determining that a health state of the video device is the unhealthy state in response to a determination that the difference between the license start date of the software and the license length is the same or less than the warning length.

9. The method of claim 1, further comprising:
receiving, by the monitoring platform, video footage from at least some of the plurality of video devices;
storing, by the monitoring platform, the video footage captured by the video devices in a video footage database.

10. The method of claim 1, further comprising causing, by the monitoring platform, a user device to display an indication of the alert.

11. The method of claim 1, wherein the video device data comprises a plurality of video device health events, wherein the method further comprises logging, by the monitoring platform, the plurality of video device health events.

12. A system for monitoring video devices of a plurality of buildings, the system comprising:
one or more memory devices configured to store instructions that, when executed on one or more processors, cause the one or more processors to:
receive video device data of a plurality of video devices of the plurality of buildings;
determine a health state of each of the plurality of video devices based on the video device data, wherein the health state is a current state of the video device and is an healthy state or an unhealthy state, wherein determining the health state comprises:
comparing the video device data to a set of rules, the set of rules comprising a license warning rule associated with a software, a license length, and a warning length; and
determining the health state of each of the plurality of video devices based on the comparison;
generate an alert in response to a determination that the health of one of the plurality of video devices is the unhealthy state; and
send the alert to an external device.

13. The system of claim 12, wherein determining the health state of each of the plurality of video devices based on the video device data comprises performing a complex event processing (CEP) analysis on the video device data, wherein the video device data comprises a plurality of video device events.

14. The system of claim 12, wherein the instructions cause the one or more processors to:
log video device events, via a complex event processing (CEP) engine, and generate alerts corresponding to the events;
monitor, via an equipment monitor, all devices relating to the plurality of buildings; and
generate user interfaces, via a user interface manager, to be displayed on an external device.

15. The system of claim 12, wherein the instructions cause the one or more processors to:
generate, via a maintenance platform, a new response case data structure, the response case data structure indicating that the video system device is experiencing a fault; and
add, via the maintenance platform, the new response case data structure to a queue list of a plurality of other response case data structures.

16. The system of claim 12, further comprising:
in response to determining that the health state of one of the plurality of video devices is the unhealthy state, automatically implementing an action to resolve the unhealthy state.

17. The system of claim 16, the set of rules comprising a video server offline rule associated with a predefined offline time;
wherein comparing the video device data to the video server offline rule comprises:
determining a length of time that a video server the plurality of video devices has been offline based on the video device data; and
determining whether the length of time that the video server has been offline is the same as or greater than the predefined offline time of the video server offline rule;
wherein determining the health state of each of the plurality of video devices based on the comparison comprises determining that a health state of the video server is the unhealthy state in response to a determination that the length of time that the video server has been offline is the same as or greater than the predefined offline time of the video server offline rule.

18. The system of claim 16, the set of rules comprising a video device disconnected rule;
wherein comparing the video device data to the video device disconnected rule comprises determining whether a video device has been disconnected based on the video device data;
wherein determining the health state of each of the plurality of video devices based on the comparison comprises determining that a health state of the video device is the unhealthy state in response to a determination that the video device has been disconnected.

19. The system of claim 12, wherein comparing the video device data to the license warning rule comprises:
determining whether the video device uses the software;
determining whether a difference between a license start date of the software and the license length is the same or less than the warning length;
wherein determining the health state of each of the plurality of video devices based on the comparison comprises determining that a health state of the video device is the unhealthy state in response to a determination that the difference between the license start date of the software and the license length is the same or less than the warning length.

20. A building system of a building, the system comprising:
building equipment configured to operate to control one or more security conditions of the building, the building equipment comprising one or more video devices configured to collect video data;
a processing circuit configured to:
receive video device data of a plurality of video devices of the plurality of buildings;
determine a health state of each of the plurality of video devices based on the video device, wherein the health state is a current state of the video device and is an healthy state or an unhealthy state, wherein determining the health state comprises;
comparing the video device data to a set of rules, the set of rules comprising a license warning rule associated with a software, a license length, and a warning length; and
determining the health state of each of the plurality of video devices based on the comparison;
wherein determining the health state of each of the plurality of video devices based on the comparison comprises determining that a health state of the video device is the unhealthy state in response to a determination that the difference between a license start date of the software and the license length is the same or less than the warning length;
generate an alert in response to a determination that the health of one of the plurality of video devices is the unhealthy state;
send the alert to an external device;
in response to determining the health state of one of the plurality of video devices is the unhealthy state, automatically implementing an action to resolve the unhealthy state; and
provide a graphical representation of the health state of each of the plurality of video devices on a user display.
